(19) United States
(12) Patent Application Publication
(10) Pub. No.: US 2016/0177879 A1
(43) Pub. Date: Jun. 23, 2016

(54) METHOD AND SYSTEM FOR A GAS TURBINE ENGINE PURGE CIRCUIT WATER INJECTION

(71) Applicant: General Electric Company, Schenectady, NY (US)

(72) Inventor: Pierre Montagne, Lay Saint Christophe (FR)

(21) Appl. No.: 14/966,578

(22) Filed: Dec. 11, 2015

(30) Foreign Application Priority Data
Dec. 23, 2014 (FR) 1463235

(51) Int. Cl. F02M 25/03; F02M 25/022; F02M 55/00; F02M 23/14; F02C 7/232; F02C 7/057

(52) U.S. Cl. CPC F02M 25/03; F02C 7/232; F02C 7/057; F02M 55/007; F02M 23/14; F02M 25/0227

(57) ABSTRACT

A method and fuel supply system for supply of a combustion chamber with at least one combustible fluid are provided. The fuel supply system includes a combustion chamber including a fuel injector, at least one supply circuit configured to supply the combustion chamber with a combustible fluid, and at least one purge circuit configured to purge the supply circuit, the purge circuit connected to a purge air source and the at least one supply circuit, the purge circuit including at least two isolation valves defining a cavity between the at least two isolation valves, the purge circuit including a water injection circuit configured to inject water into the cavity, the purge circuit including a cavity draining circuit configured to drain the cavity.

### CROSS REFERENCE TO RELATED APPLICATIONS

This application claims the benefit of French Patent Application No. 1463235 filed on Dec. 23, 2014, the entirety of which is incorporated herein.

### BACKGROUND

The field of the disclosure relates generally to gas turbine engines and, more particularly, to a system and method of supplying a purge fluid to a cavity of a fuel supply circuit.

At least some known gas turbine engines include a compressor, one or more combustion chambers and an expansion turbine. The combustion chambers are supplied with gaseous fuel through a fuel supply system to be mixed therein with pressurized relatively high temperature air from the compressor. The fuel supply system permits several types of fuels, for example, natural gas, liquid fuel or synthetic gas or “syngas” to be supplied to the combustion chambers. The fuel supply system permits regulating a plurality of fuel supply system parameters from the fuel source to the one or more combustion chambers. Specifically, fuel supply systems typically permit regulating the fuel pressure, fuel temperature and fuel flow to the one or more combustion chambers.

To permit routing and transfer of various types of fuels to the gas turbine engine, and ensure regulation of pressure, temperature and flow conditions, the supply circuit includes isolation valves, flow regulation valves, and cooling and filtration systems.

Furthermore, the fuel supply system must be capable of ensuring separation of portions of the fuel supply system, for example, of cavities, to avoid contact between relatively high temperature air and the gaseous fuel sources to prevent self-ignition of the fuel and creation of explosive mixtures. Typically, a gas turbine engine is operated on one of two types of fuels. For example, the first fuel is natural gas and the second fuel is synthetic gas or syngas, each fuel supplied through a separate circuit for at least a portion of the fuel supply system. Each fuel circuit, when not in use, may be purged with relatively high temperature air extracted from the turbine compressor. To isolate each fuel circuit from this relatively high temperature air, a cavity sometimes referred to as a “block and bleed” valve arrangement is generally used. When the valves of the “block and bleed” valve arrangement are incorporated in a single component, the single component is referred to as a block and bleed manifold. After using a fuel supply circuit, it is purged with an inert gas, for example, nitrogen, before introduction of relatively high temperature scavenging air to avoid creating an explosive mixture.

For example, if the second fuel supply circuit is isolated during a securing of the gas turbine engine or a change of fuel from the second fuel to the first fuel, no fuel circulates in the second fuel circuit and the supply circuit of the second fuel is purged with relatively high temperature air. During this purge phase, a flow of relatively high temperature air is maintained towards the passages in the injectors provided for the second fuel to avoid condensation and/or burning the nozzle tip and limit the risk of a return of gas from the combustion chamber to the second fuel supply circuit.

When the valves controlling the fuel or relatively high temperature air supply for purging are closed, there still is a risk, in some cases, of fuel gas leakage into the dead leg cavities formed by the isolation valves and, thus, a risk of contact between the relatively high temperature purge air, whose temperature may attain 500° C., and the fuel.

Known solutions using inert gases to ensure separation between the fuel and purge relatively high temperature air include filling a cavity between two isolation valves at a predetermined pressure and maintaining an appropriate pressure to compensate for any fuel pressure and relatively high temperature purge air pressure variations. However, maintaining a high pressure of inert gas in the cavity may require an expensive compression system and may also consume a large quantity of inert gas to make-up for leakage through, for example, the isolation valves. Maintaining a high pressure of inert gas in the cavity may also be influenced by other factors, such as ambient temperature and turbine load level. This technique also imposes the need for storage of inert gas at high pressure.

Furthermore, cleaning of the isolation valves of the fuel supply circuit is needed for the efficient operation of the gas turbine engine and of the fuel supply circuit. Maintenance of the block and bleed valves is conducted through physical inspection and/or through pressurization tests, which are laborious and require decommissioning of the turbine during the time period of the inspection or tests. Although other methods permit testing the valves online, these methods require changing the turbine fuel supply circuit and installing branches or bypasses to ensure continuous supply of fuel to the combustion chambers.

### BRIEF DESCRIPTION

In one aspect, a fuel supply system for supply of a combustion chamber with at least one combustible fluid includes a combustion chamber including a fuel injector, at least one supply circuit configured to supply the combustion chamber with a combustible fluid, and at least one purge circuit configured to purge the supply circuit, the purge circuit connected to a purge air source and the at least one supply circuit, the purge circuit including at least two isolation valves defining a cavity between the at least two isolation valves, the purge circuit including a water injection circuit configured to inject water into the cavity, the purge circuit including a cavity draining circuit configured to drain the cavity.

In another aspect, a method of supplying a combustion chamber with at least one combustible fluid using a fuel supply system is provided. The fuel supply system is coupled in flow communication with a first purge system that includes at least two isolation valves that define a cavity therebetween. The method includes filling the cavity with water, channeling the at least one combustible fluid to the combustion chamber through a fuel supply isolation valve, and venting from the water-filled cavity at least one of air and the at least one combustible fluid leaking by any of the at least two isolation valves.

In yet another aspect, a gas turbine engine system includes a compressor including a low pressure inlet, a high pressure outlet, and a bleed port configured to extract air at a pressure between the low pressure inlet and the high pressure outlet. The gas turbine engine system also includes a combustion chamber including a fuel injector, a turbine coupled in serial flow communication with the compressor and the combustion chamber, and at least one supply circuit configured to supply the combustion chamber with a combustible fluid. The gas turbine engine system further includes at least one purge circuit configured to purge the supply circuit, the purge circuit connected to a purge air source and the at least one supply circuit, the purge circuit including at least two isolation valves defining a cavity between the at least two isolation valves, the purge circuit including a water injection circuit configured to inject water into the cavity, the purge circuit including a cavity draining circuit configured to drain the cavity.

### DRAWINGS

These and other features, aspects, and advantages of the present disclosure will become better understood when the following detailed description is read with reference to the accompanying drawings in which like characters represent like parts throughout the drawings, wherein:

FIG. 1 is a schematic piping diagram of a fuel supply system for a combustion chamber of a gas turbine engine including a relatively high temperature air purge system;

FIG. 2 is a logic table illustrating a state of fuel supply system in a plurality of modes of operation; and

FIG. 3 is a flow chart of a method of supplying a combustion chamber with at least one combustible fluid using a fuel supply system.

Unless otherwise indicated, the drawings provided herein are meant to illustrate features of embodiments of this disclosure. These features are believed to be applicable in a wide variety of systems comprising one or more embodiments of this disclosure. As such, the drawings are not meant to include all conventional features known by those of ordinary skill in the art to be required for the practice of the embodiments disclosed herein.

### DETAILED DESCRIPTION

In the following specification and the claims, reference will be made to a number of terms, which shall be defined to have the following meanings.

The singular forms “a”, “an”, and “the” include plural references unless the context clearly dictates otherwise.

“Optional” or “optionally” means that the subsequently described event or circumstance may or may not occur, and that the description includes instances where the event occurs and instances where it does not.

Approximating language, as used herein throughout the specification and claims, may be applied to modify any quantitative representation that could permissibly vary without resulting in a change in the basic function to which it is related. Accordingly, a value modified by a term or terms, such as “about”, “approximately”, and “substantially”, are not to be limited to the precise value specified. In at least some instances, the approximating language may correspond to the precision of an instrument for measuring the value. Here and throughout the specification and claims, range limitations may be combined and/or interchanged; such ranges are identified and include all the sub-ranges contained therein unless context or language indicates otherwise.

Embodiments of the disclosure describe providing a supply of purge media for a combustion chamber, such as, of a gas turbine engine. The supply of purge media permits reducing an amount of inert gas used for purging the fuel supply circuits associated with the combustion chamber.

A combustion chamber includes at least one fuel supply circuit for supplying the combustion chamber with combustible fluid and at least one purge circuit. The purge circuit is coupled in flow communication with the at least one fuel supply circuit and an air source from the turbine compressor and includes at least two isolation valves defining a cavity between them. The cavity is coupled in flow communication to a water supply circuit through a water injection device and a cavity draining circuit. Injecting water into the cavity, which is positioned between the fuel supply circuit, the purge air source, and the two isolation valves of the purge circuit, reduces the possibility of contact between the fuel and purge air, which is undesirable.

In various embodiments, the cavity includes at least one vent opening to ambient. In other embodiments, the cavity includes two vents, one vent associated with each isolation valve. The cavity has a profile including two slopes converging towards the water injection device in the cavity. Each one of these slopes extends from one of the vents. Additionally, the cavity includes a water level detection device in the vents and in the cavity draining circuit. A second purge circuit connected to a source of inert gas is optionally provided.

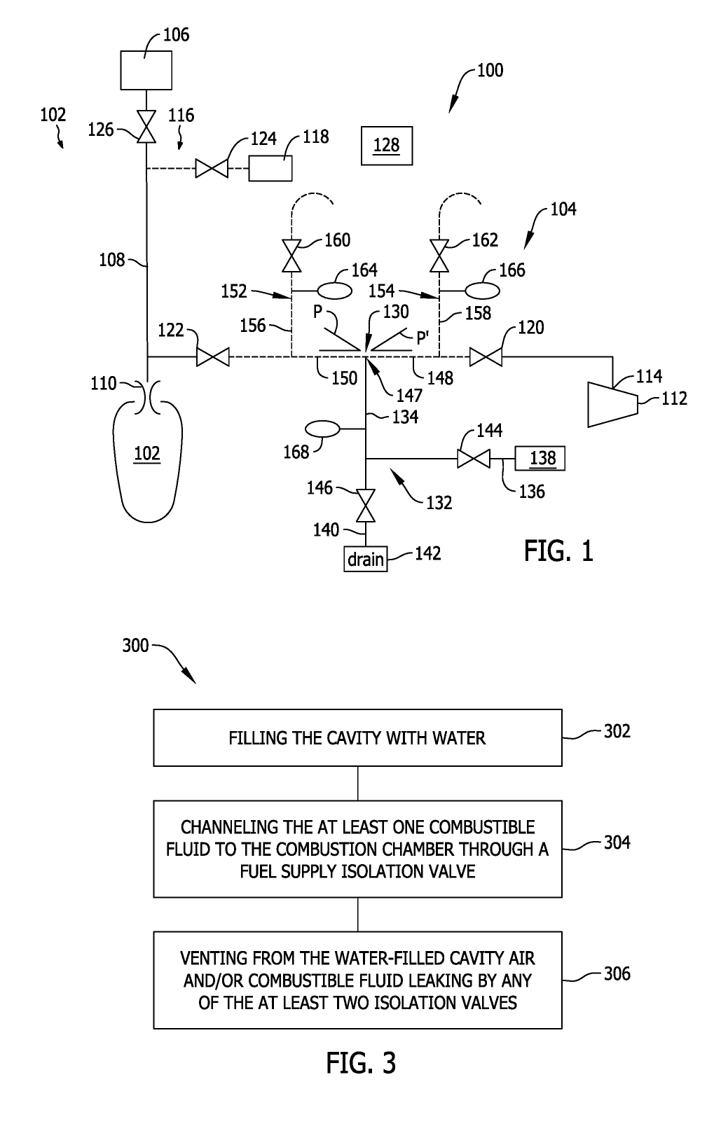

FIG. 1 is a schematic piping diagram of a fuel supply system 100 for a combustion chamber 102 of a gas turbine engine (not shown) including a relatively high temperature air purge system 104. In the example embodiment, fuel supply system 100 includes a source 106 of fuel gas, for example, a gaseous fuel, such as natural gas, liquid fuel or synthetic gas or “syngas.” A fuel supply circuit 108 is configured to channel the fuel from fuel source 106 to one or more fuel injectors 110 of combustion chamber 102. In the example embodiment, fuel source 106 represents a plurality of fuel supply piping arrangements configured to provide various types of fuel to fuel supply circuit 108 and ultimately to fuel injector 110.

High temperature air purge system 104 is coupled inflow communication to a purge air source 112, such as, but not limited to a bleed port 114 of a turbine compressor of the gas turbine engine.

High temperature air purge system 104 is configured to continuously scavenge fuel supply system 100 and one or more fuel injectors 110 with relatively high temperature air from bleed port 114 to purge fuel supply system 100 and reduce the possibility of condensate and/or gas from the combustion chamber returning to fuel supply system 100.

Fuel supply system 100 includes an inert gas purge supply circuit 116 communicatively coupled to fuel supply circuit 108. Inert gas purge supply circuit 116 includes a source of inert gas 118, such as, a source of nitrogen gas and is used before implementation of relatively high temperature air purge system 104, to reduce the possibility of any contact between the fuel and relatively high temperature air from bleed port 114.

Fuel supply system 100, high temperature air purge system 104 and inert gas purge supply circuit 116 each include a set of isolation valves, such as purge air isolation valve 120, fuel supply circuit isolation valve 122, inert gas purge circuit isolation valve 124, and fuel supply system isolation valve 126 controlled by a remote control unit 128 communicatively coupled to each of valves 120, 122, 124, and 126, as well as other valves of fuel supply system 100, as described below. Remote control unit 128 controls a sequence of operation of the valves to permit implementation of the various phases or states of fuel supply system 100, such as, a supply phase and a purge phase.

For example, fuel supply system isolation valve 126 of fuel supply system 100 is controlled on opening to cause a flow of fuel to combustion chamber 102. Inert gas purge circuit isolation valve 124 is controlled on opening to purge fuel supply system 100 of fuel, after stopping of the fuel supply. Purge air isolation valve 120 and fuel supply circuit isolation valve 122 are controlled on opening to purge fuel supply circuit 108 and fuel injectors 110.

High temperature air purge system 104 includes two isolation valves, purge air isolation valve 120 and fuel supply circuit isolation valve 122, which are provided to a possibility of contact between purge air from bleed port 114 and fuel from fuel source 106, during normal operation of fuel supply system 100 and, specifically, during the supply of combustion chamber 102 with fuel.

Purge air isolation valve 120 and fuel supply circuit isolation valve 122 define between them a cavity 130, i.e. a part of high temperature air purge system 104 separating relatively high temperature air from bleed port 114 and the fuel in fuel supply circuit 108.

As indicated above, specifically due to a size of the valves in fuel supply system 100, it was noted that there could be potential gas leaks through the valves, even when closed, and specifically in purge air isolation valve 120 and fuel supply circuit isolation valve 122.

To avoid any risk of contact between relatively high temperature purge air from bleed port 114 and fuel in cavity 130, fuel supply system 100 includes a water supply circuit 132 configured to fill cavity 130 with water when purge air isolation valve 120 and fuel supply circuit isolation valve 122 are closed and fuel supply system isolation valve 126 is open. Water supply circuit 132 includes a main pipe 134 coupled in flow communication with cavity 130, a first secondary pipe 136 that communicates with a water source 138 and a second secondary pipe 140 that terminates in a drain 142 for water evacuation before implementation of a relatively high temperature air purge phase.

Each one of the two secondary pipes 136 and 140 are fitted with a water supply isolation valve 144 and a drain isolation valve 146, respectively, which communicate with main pipe 134.

Main pipe 134 terminates in cavity 130, preferably in its median zone 147, i.e. located approximately midway between purge air isolation valve 120 and fuel supply circuit isolation valve 122, defining on each side, two half-cavities 148 and 150. Half-cavity 148 includes a slope P and half-cavity 150 includes a slope P′, directed downwards in the direction of median zone 147. Slope P and slope P′ facilitate preventing the spread of potential fuel leaks in the direction of purge air isolation valve 120 and fuel supply circuit isolation valve 122. In some embodiments, slope P and/or slope P′ are constant. In other embodiments, slope P and/or slope P′ vary along a length of at least one of half-cavities 148 and 150. In various embodiments, secondary pipes 136 and the drain 142 are independent and do not flow towards main pipe 134.

Fuel supply system 100 includes at least two vents, 152 and 154, each including two lines, 156 and 158, respectively, coupled in flow communication to cavity 130 for gas evacuation from cavity 130. Line 156 is coupled to cavity 130 proximate fuel supply circuit isolation valve 122 and line 158 is coupled to cavity 130 proximate purge air isolation valve 120. Each of lines 156 and 158 includes a respective vent isolation valve, half-cavity vent isolation valve 160 and half-cavity vent isolation valve 162, which, in various embodiments, are controlled by remote control unit 128 to channel gas evacuation towards ambient. Venting may be required when a leakage of gaseous fuel through valve fuel supply circuit isolation valve 122, or leakage of relatively high temperature purge air, through purge air isolation valve 120 enters cavity 130.

Fuel supply system 100 also includes a plurality of water level sensors for detecting the water level in vents 152 and 154 and in water supply circuit 132. A water level sensor 164 is positioned in vent 152 immediately upstream of half-cavity vent isolation valve 160, a water level sensor 166 is positioned in vent 154 immediately upstream of half-cavity vent isolation valve 162, and a water level sensor 168 is positioned in water supply circuit 132 proximate a connection of main pipe 134 to cavity 130.

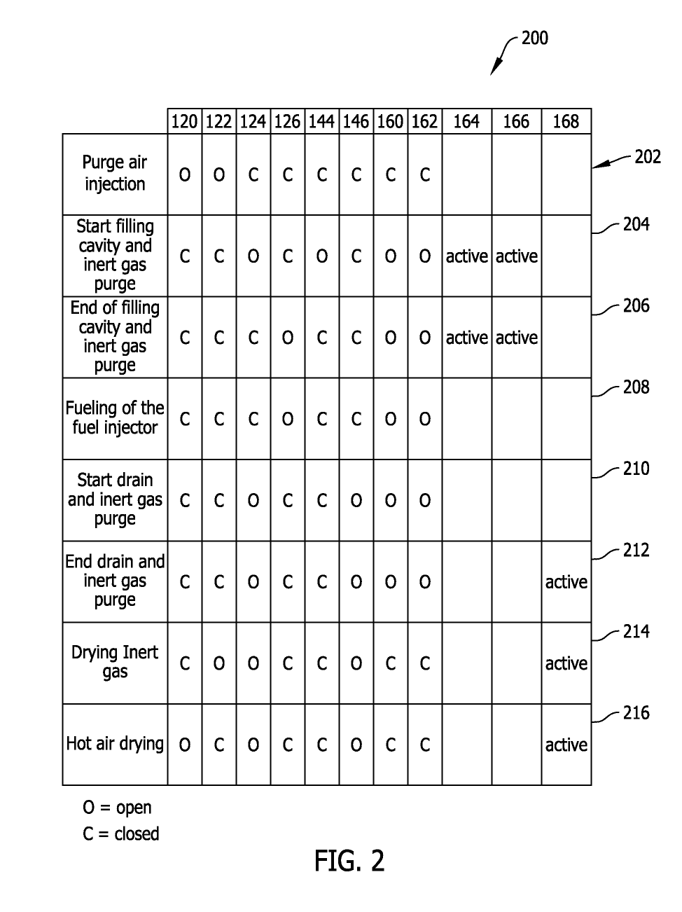

FIG. 2 is a logic table 200 illustrating a state of fuel supply system 100 in a plurality of modes of operation. During normal operation of fuel supply system 100, i.e. when fuel injectors 110 are supplied with fuel, as illustrated in row 208 of logic table 200, fuel supply system isolation valve 126 is opened (state O). Purge air isolation valve 120 and fuel supply circuit isolation valve 122 are closed (state F) and inert gas purge circuit isolation valve 124 of inert gas purge supply circuit 116 is closed. In this phase, cavity 130 is filled with water.

Water supply isolation valve 144 is closed, drain isolation valve 146 is also closed. Half-cavity vent isolation valve 160 and half-cavity vent isolation valve 162 are opened.

Because of slopes P and P′, fuel leaks likely to appear through valve fuel supply circuit isolation valve 122 are evacuated through vent 152 located proximate fuel supply circuit isolation valve 122 and proximate a high point of half-cavity 150, whereas the relatively high temperature purge air leaks likely to appear through purge air isolation valve 120 are evacuated through vent 154 located proximate purge air isolation valve 120 and at a high point of half-cavity 148.

It will be noted that even in cases where gaseous fuel leaks come in contact with purge air, the gaseous fuel/high temperature air mixture occurs at a relatively low temperature due to the cooling caused by water filling the cavity, for example, at room temperature, i.e. at a temperature much lower than the self-ignition temperature of the gaseous fuel. For example, the self-ignition temperature of methane is approximately 570° C. at room temperature, propane approximately 470° C. and butane approximately 287° C. In all cases, this mixing occurs in water-filled cavity 130 preventing combustion of the mixture.

As shown in row 210 of table 200, after stopping of the gaseous fuel supply by closing fuel supply system isolation valve 126, inert gas purge circuit isolation valve 124 is opened to proceed with the purge of fuel supply circuit 108.

In this purge phase of fuel supply circuit 108, cavity 130 is drained by opening drain isolation valve 146. When water level sensor 168 no longer indicates the presence of water in cavity 130, as the purge of fuel supply circuit 108 is still in progress, i.e. inert gas purge circuit isolation valve 124 is opened, half-cavity vent isolation valve 160 and half-cavity vent isolation valve 162 are closed and valve fuel supply circuit isolation valve 122 is opened. This step constitutes an inert gas “drying” phase of half-cavity 150 using inert gas that exits through drain isolation valve 146 as shown in row 214.

Also, to carry out “drying” with relatively high temperature air of the half-cavity 148, valve fuel supply circuit isolation valve 122 is closed and valve purge air isolation valve 120 is opened as shown in row 216 of table 200. The two steps of drying may take, for example, between 5 and 30 seconds.

Because cavity 130 is drained and dried, drain isolation valve 146 is closed and fuel supply circuit isolation valve 122 is opened. Purge air isolation valve 120 remains open. This final state corresponds to continuous scavenging of injectors 110, which are not supplied with fuel as shown in row 202 of table 200. In this phase, purge air isolation valve 120 and fuel supply circuit isolation valve 122 are opened. The other valves, inert gas purge circuit isolation valve 124, fuel supply system isolation valve 126, drain isolation valve 146, water supply isolation valve 144, half-cavity vent isolation valve 160 and half-cavity vent isolation valve 162 are closed.

When the continuous scavenging phase stops, for example, at the operator's request, and the combustion chambers are to be supplied with fuel through fuel supply circuit 108, as described above, a first phase of purge of fuel supply circuit 108 is carried out, then cavity 130 is filled with water as shown in row 204. In one embodiment, prior to filling cavity 130 with water, a predetermined amount of time is allowed to elapse or a predetermined temperature is achieved to permit the piping of cavity 130 to cool below the predetermined temperature, which prevents having the water vaporize by contact with hot piping, which may slowly damage piping and reduce its life.

To end the filling of cavity 130 and the inert gas purge of fuel supply circuit 108 and injectors 110, inert gas purge circuit isolation valve 124 is closed and fuel supply system isolation valve 126 is opened to permit supplying fuel to injectors 110.

FIG. 3 is a flow chart of a method 300 of supplying a combustion chamber with at least one combustible fluid using a fuel supply system. The fuel supply system is coupled in flow communication with a first purge system that includes at least two isolation valves that define a cavity therebetween. The method includes filling 302 the cavity with water, channeling 304 the at least one combustible fluid to the combustion chamber through a fuel supply isolation valve, and venting 306 from the water filled cavity air and/or the at least one combustible fluid that leaks by any of the at least two isolation valves into the water-filled cavity.

The above-described method and system provide a cost-effective method for reducing a potential mixture of leaking fuel gas and relatively high temperature purge air. Specifically, potential sources of fuel gas and the high temperature purge gas are isolated from each other by a space that is water filled during certain operational modes of the fuel supply system. More specifically, when fuel is supplied to the combustion chamber at relatively high pressure there is a potential for some leakage of fuel through a high temperature air purge isolation valve. By interposing a water-filled space downstream of the potential leakage path, mixing of the fuel gas and relatively high temperature purge air is prevented. The system also provides a controller that safely aligns system valves for the various operational and transition phases during various operational modes of the system.

Exemplary embodiments of fuel supply systems are described above in detail. The fuel supply systems and methods of operating such systems and devices are not limited to the specific embodiments described herein, but rather, components of systems and/or steps of the methods may be utilized independently and separately from other components and/or steps described herein. For example, the methods may also be used in combination with other systems requiring robust isolation of gaseous and/or liquid fluids and are not limited to practice with only the systems and methods as described herein. Rather, the exemplary embodiment can be implemented and utilized in connection with many other flow applications that are currently configured to receive and accept fluids that are not desired to be mixed.

Although specific features of various embodiments of the disclosure may be shown in some drawings and not in others, this is for convenience only. In accordance with the principles of the disclosure, any feature of a drawing may be referenced and/or claimed in combination with any feature of any other drawing.

This written description uses examples to disclose the embodiments, including the best mode, and also to enable any person skilled in the art to practice the embodiments, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A fuel supply system for supply of a combustion chamber with at least one combustible fluid, said fuel supply system comprising:
a combustion chamber comprising a fuel injector;
at least one supply circuit configured to supply said combustion chamber with a combustible fluid; and
at least one purge circuit configured to purge said supply circuit, said purge circuit connected to a purge air source and said at least one supply circuit, said purge circuit comprising at least two isolation valves defining a cavity between the at least two isolation valves, said purge circuit comprising a water injection circuit configured to inject water into said cavity, said purge circuit comprising a cavity draining circuit configured to drain said cavity.

2. The fuel supply system of claim 1, wherein said cavity includes at least one vent ending outside the fuel supply system.

3. The fuel supply system of claim 2, wherein said cavity includes two vents positioned proximate respective isolation valves defining the cavity therebetween.

4. The fuel supply system of claim 3, wherein said cavity includes a profile comprising at least one slope extending from proximate one of said vents towards said water injection circuit.

5. The fuel supply system of claim 2, wherein said at least one vent comprises a water level detector.

6. The fuel supply system of claim 1, wherein said cavity draining circuit comprises a water level detector.

7. The fuel supply system of claim 1, further comprising a second purge circuit of the supply circuit connected to a source of inert gas.

8. The fuel supply system of claim 1, wherein said supply circuit is configured to supply at least one combustible fluid to a gas turbine engine combustion chamber.

9. A method of supplying a combustion chamber with at least one combustible fluid using a fuel supply system, the fuel supply system coupled in flow communication with a first purge system, the first purge system including at least two isolation valves that define a cavity therebetween, the method comprising:
filling the cavity with water;
channeling the at least one combustible fluid to the combustion chamber through a fuel supply isolation valve; and
venting from the water-filled cavity at least one of air and the at least one combustible fluid leaking by any of the at least two isolation valves.

10. The method of claim 9, wherein the first purge system includes a cavity drain system coupled in flow communication with the cavity, said method further comprising draining the cavity through the cavity drain system when the fuel supply isolation valve is closed.

11. The method of claim 10, further comprising:
opening the at least two isolation valves;
supplying a flow of relatively high temperature air to the cavity through at least one of the at least one isolation valves; and
drying the cavity using the flow of relatively high temperature air.

12. The method of claim 9, wherein the fuel supply system includes an inert gas purge system coupled in flow communication with the fuel supply system through an inert gas purge system isolation valve, said method further comprising:
closing the fuel supply isolation valve; and
opening the inert gas purge system isolation valve to channel a flow of inert gas through at least a portion of the fuel supply system to the combustion chamber.

13. The method of claim 12, further comprising draining the cavity.

14. A gas turbine engine system comprising:
a compressor comprising a low pressure inlet, a high pressure outlet, and a bleed port configured to extract air at a pressure between the low pressure inlet and the high pressure outlet;
a combustion chamber comprising a fuel injector;
a turbine coupled in serial flow communication with said compressor and said combustion chamber;
at least one supply circuit configured to supply said combustion chamber with a combustible fluid; and
at least one purge circuit configured to purge said supply circuit, said purge circuit connected to a purge air source and said at least one supply circuit, said purge circuit comprising at least two isolation valves defining a cavity between the at least two isolation valves, said purge circuit comprising a water injection circuit configured to inject water into said cavity, said purge circuit comprising a cavity draining circuit configured to drain said cavity.

15. The gas turbine engine system of claim 14, wherein said cavity includes at least one vent ending outside the fuel supply system.

16. The fuel supply system of claim 15, wherein said cavity includes two vents positioned proximate respective isolation valves defining the cavity therebetween.

17. The fuel supply system of claim 16, wherein said cavity includes a profile comprising at least one slope extending from proximate one of said vents towards said water injection circuit.

18. The fuel supply system of claim 15, wherein said at least one vent comprises a water level detector.

19. The fuel supply system of claim 14, wherein said cavity draining circuit comprises a water level detector.

20. The fuel supply system of claim 14, further comprising a second purge circuit of the supply circuit connected to a source of inert gas.
